(19) United States
(12) Patent Application Publication
(10) Pub. No.: US 2024/0386031 A1
(43) Pub. Date: Nov. 21, 2024

(54) Real-time data modeling for data warehouse using quantum computing

(71) Applicant: Bank of America Corporation, Charlotte, NC (US)

(72) Inventors: Arunkumar Somasundaram, Coimbatore (IN); Udhayan M, Madurai (IN); Lalitha Rajeswari Karanam, Hyderabad (IN); Balamurali Lakshminarayanan, Chennai (IN); Shwethaa S, Chennai (IN); Lakka Manju, Hyderabad (IN)

(21) Appl. No.: 18/319,099

(22) Filed: May 17, 2023

(51) Int. Cl. G06F 16/28; G06N 10/60

(52) U.S. Cl. CPC G06F 16/283; G06N 10/60

(57) ABSTRACT

A method includes receiving production data items from a data warehouse. New data items are received and converted to structured new data items. The production data items are converted from classical to quantum bits to determine converted production data items. The structured new data items are converted from classical to quantum bits to determine converted structured new data items. The converted production data items are entangled with the converted structured new data items one or more times until a correlation score is greater than a correlation threshold to obtain correlated data items. The correlated data items are converted from quantum to classical bits to determine converted correlated data items. Data dictionary is created for the structured new data items based on the converted correlated data items. Data objects are created for the structured new data items based on the data dictionary. The data objects are deployed to the data warehouse.

### TECHNICAL FIELD

The present disclosure relates generally to data modeling, and more specifically to a system and method for real-time data modeling for data warehouse using quantum computing.

### BACKGROUND

A data warehouse receives huge volumes of unstructured data that need to be modeled and integrated into the data warehouse in real-time. Methods based on classical computing fail to provide efficient data modeling of the unstructured data.

### SUMMARY

The system described in the present disclosure provides several practical applications and technical advantages that overcome the current technical problems with data modeling.

In general, a system real-time data modeling for data warehouse using quantum computing includes a data warehouse and a data modeling system communicatively coupled to each other via a network. The data warehouse includes a memory. The memory is configured to store a plurality of production data items. The data modeling system includes a classical processor and a quantum processor communicatively coupled to each other and the memory. The quantum processor implements a variational quantum eigensolver algorithm.

The data modeling system scans the plurality of production data items stored in the memory of the data warehouse to determine a data structure of the plurality of production data items. The data modeling system receives a plurality of new data items from a computing device of a user. The data modeling system converts the plurality of new data items into a plurality of structured new data items. The data modeling system converts the plurality of production data items from classical binary bits to quantum bits. The data modeling system converts the plurality of structured new data items from classical binary bits to quantum bits. The data modeling system sets variational parameters. The data modeling system entangles the plurality of structured new data items with the plurality of production data items to obtain a plurality of correlated data items. The data modeling system determines a correlation score between the plurality of structured new data items and the plurality of production data items. The transformation of data items from classical binary bits to quantum bits allows for applying quantum algorithms (e.g., as a variational quantum eigensolver algorithm) using quantum processors. By using quantum processors implementing quantum algorithms, speed of operations is increased due to quantum parallelism compared to classical algorithms executed by classical processors.

In response to determining that the correlation score is not greater than a correlation score threshold, the data modeling system updates the variational parameters and repeats the entanglement process between the plurality of structured new data items and the plurality of production data items until the correlation score is greater than the correlation score threshold.

In response to determining that the correlation score is greater than the correlation score threshold, the data modeling system converts the plurality of correlated data items from quantum bits to classical binary bits.

The data modeling system determines a data type for each of the plurality of structured new data items. The data modeling system creates a data dictionary for the plurality of structured new data items based on the plurality of correlated data items. The data modeling system creates data objects for the plurality of structured new data items based on the data dictionary. The data modeling system reconciles the data objects. In certain embodiments, the reconciliation process comprises performing incremental changes to the data objects. The data modeling system tests the data objects. In response to determining that the data objects are approved, the data modeling system deploys the data objects to the data warehouse.

The system for real-time data modeling allows for efficient data modeling of unstructured data. By using a quantum processor implementing a quantum algorithm (e.g., variational quantum eigensolver algorithm), speed of data modeling is increased due to quantum parallelism compared to classical algorithms executed by classical processors.

Accordingly, the following disclosure is particularly integrated into practical applications of: (1) efficient data modeling of unstructured data; and (2) improving speed of data modeling by using quantum processors that implement quantum algorithms.

In one embodiment, a system includes a data warehouse and a data modeling system communicatively coupled to the data warehouse. The data warehouse includes a memory configured to store a plurality of production data items. The data modeling system includes a classical processor, a quantum processor, and a converter communicatively coupled to each other. The classical processor is configured to receive the plurality of production data items from the data warehouse, receive a plurality of new data items, convert the plurality of new data items to a plurality of structured new data items, send the plurality of production data items and the plurality of structured new data items to the converter, receive a plurality of converted correlated data items from the converter, create a data dictionary for the plurality of structured new data items based on the plurality of converted correlated data items, create a plurality of data objects for the plurality of structured new data items based on the data dictionary, reconcile the plurality of data objects, test the plurality of data objects, in response to determining that the plurality of data objects are approved, deploy the plurality of data objects to the data warehouse. The quantum processor is configured to receive a plurality of converted production data items and a plurality of converted structured new data items from the converter, entangle the plurality of converted production data items with the plurality of converted structured new data items one or more times until a correlation score is greater than a correlation threshold to obtain a plurality of correlated data items, and send the plurality of correlated data items to the converter. The converter is configured to convert the plurality of production data items from classical binary bits to quantum bits to determine the plurality of converted production data items, convert the plurality of structured new data items from classical binary bits to quantum bits to determine the plurality of converted structured new data items, and convert the plurality of correlated data items from quantum bits to classical binary bits to determine the plurality of converted correlated data items.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates an embodiment of a system for real-time data modeling for data warehouse using quantum computing; and

FIGS. 2A and 2B illustrate an example operational flow of system of FIG. 1 for real-time data modeling for data warehouse using quantum computing.

### DETAILED DESCRIPTION

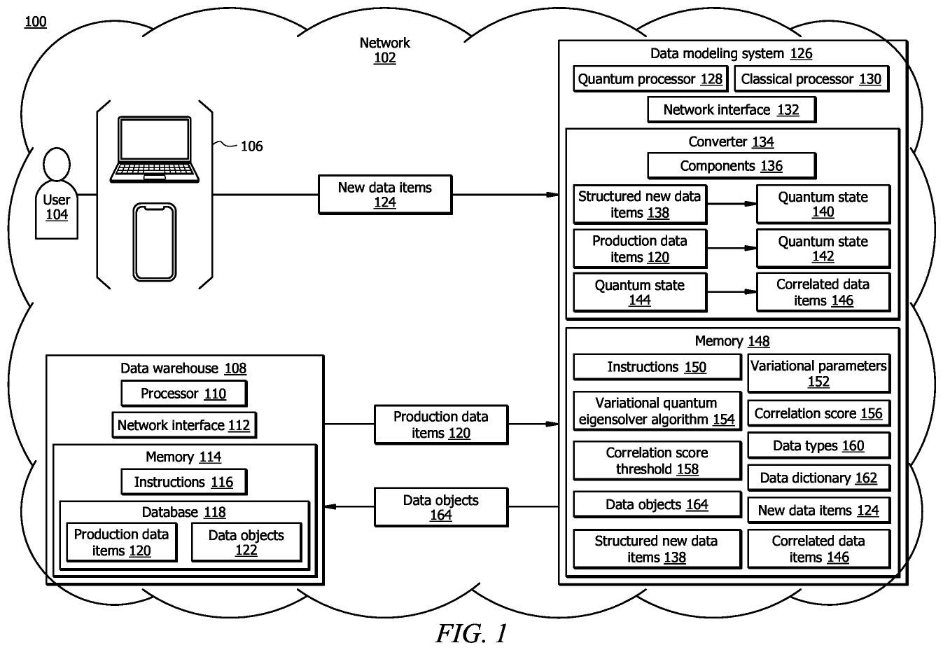

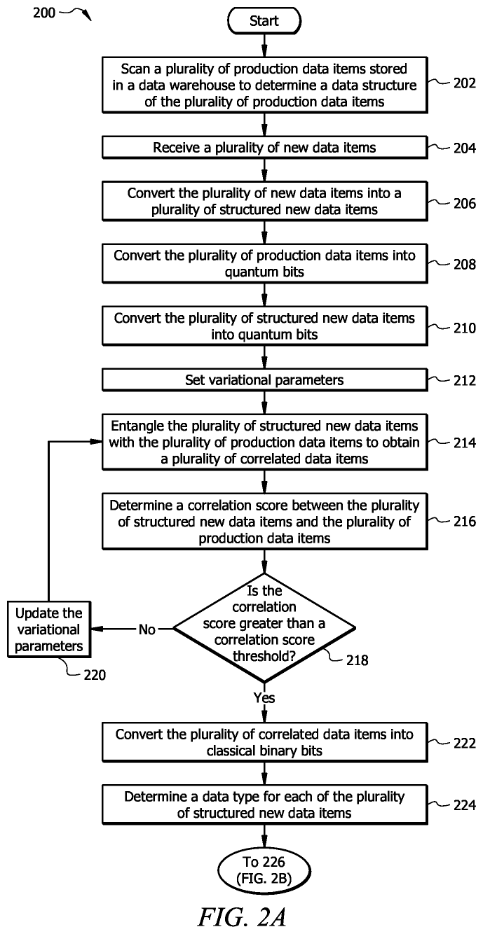

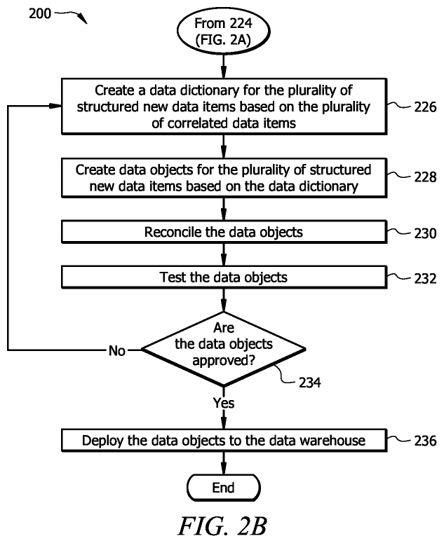

As described above, previous technologies fail to provide effective systems and methods for data modeling. Embodiments of the present disclosure and their advantages may be understood by referring to FIGS. 1, 2A, and 2B. FIGS. 1, 2A, and 2B are used to describe a system and method for real-time data modeling for data warehouse using quantum computing.

System overview

FIG. 1 illustrates an embodiment of a system 100 for real-time data modeling for data warehouse using quantum computing. In certain embodiments, the system 100 comprises a data warehouse 108 operably coupled to a data modeling system 126 via a network 102. Network 102 enables the communication between the components of the system 100. The system 100 may be coupled to a computing device 106 of a user 104 via the network 102. In other embodiments, the system 100 may not have all the components listed and/or may have other elements instead of, or in addition to, those listed above. For example, the data warehouse 108 and the data modeling system 126 may be integrated into a single system.

In general, a data modeling system 126 scans a plurality of production data items 120 stored in memory 114 of a data warehouse 108 to determine a data structure of the plurality of production data items 120. The data modeling system 126 receives a plurality of new data items 120 from a computing device 106 of a user 104. The data modeling system 126 converts the plurality of new data items 124 into a plurality of structured new data items 138. The data modeling system 126 converts the plurality of production data items 120 from classical binary bits to quantum bits. The data modeling system 126 converts the plurality of structured new data items 138 from classical binary bits to quantum bits. The data modeling system 126 sets variational parameters 152. The data modeling system 126 entangles the plurality of structured new data items 138 with the plurality of production data items 120 to obtain a plurality of correlated data items 146. The data modeling system 126 determines a correlation score 156 between the plurality of structured new data items 138 and the plurality of production data items 120.

In response to determining that the correlation score 156 is not greater than a correlation score threshold 158, the data modeling system 126 updates the variational parameters 152 and repeats the entanglement process between the plurality of structured new data items 138 and the plurality of production data items 120 until the correlation score 156 is greater than the correlation score threshold 158.

In response to determining that the correlation score 156 is greater than the correlation score threshold 158, the data modeling system 126 converts the plurality of correlated data items 146 from quantum bits to classical binary bits.

The data modeling system 126 determines a data type 160 for each of the plurality of structured new data items 138. The data modeling system 126 creates a data dictionary 162 for the plurality of structured new data items 138 based on the plurality of correlated data items 146. The data modeling system 126 creates data objects 164 for the plurality of structured new data items 138 based on the data dictionary 162. The data modeling system 126 reconciles the data objects 164. In certain embodiments, the reconciliation process comprises performing incremental changes to the data objects 164. The data modeling system 126 tests the data objects 164. In response to determining that the data objects 164 are approved, the data modeling system 126 deploys the data objects 164 to the data warehouse 108.

### System Components

### Network

Network 102 may be any suitable type of wireless and/or wired network. The network 102 may or may not be connected to the Internet or public network. The network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMax, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

### Computing Device

Computing device 106 is generally any device that is configured to process data and interact with a user 104. Examples of the computing device 104 include, but are not limited to, a personal computer, a desktop computer, a workstation, a server, a laptop, a tablet computer, a mobile phone (such as a smartphone), etc. The computing device 106 may include a user interface, such as a display, a microphone, keypad, or other appropriate terminal equipment usable by the user 104. The computing device 106 may include a hardware processor, memory, and/or circuitry (not explicitly shown) configured to perform any of the functions or actions of the computing device 106 described herein. For example, a software application designed using software code may be stored in the memory and executed by the processor to perform the functions of the computing device 106. The computing device 106 is configured to communicate with other components of the system 100 via the network 102. In operation, the computing device 106 of the user 104 may communicate new data items 124 to the data modeling system 126.

### Data Warehouse

The data warehouse 108 is generally any device that is configured to process data and communicate with other components of the system 100 via the network 102. The data warehouse 108 may comprise a processor 110 in signal communication with a memory 114 and a network interface 112.

Processor 108 comprises one or more processors operably coupled to the memory 114. The processor 108 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 108 may be a programmable logic device, a microcontroller, a microprocessor, or any suitable combination of the preceding. The one or more processors are configured to process data and may be implemented in hardware or software. For example, the processor 108 may be 8-bit, 16-bit, 32-bit, 64-bit, or of any other suitable architecture. The one or more processors are configured to implement various software instructions to perform the operations described herein. For example, the one or more processors are configured to execute software instructions 116 and perform one or more functions described herein. The processor 108 may be also referred to as a classical processor. Network interface 112 is configured to enable wired and/or wireless communications (e.g., via network 102). The network interface 112 is configured to communicate data between the data warehouse 108 and other components of the system 100. For example, the network interface 112 may comprise a WIFI interface, a local area network (LAN) interface, a wide area network (WAN) interface, a modem, a switch, or a router. The processor 108 is configured to send and receive data using the network interface 112. The network interface 112 may be configured to use any suitable type of communication protocol as would be appreciated by one of ordinary skill in the art.

Memory 114 may be volatile or non-volatile and may comprise a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1, 2A, and 2B along with any other data, instructions, logic, rules, or code operable to implement the function(s) described herein. The memory 114 is operable to store software instructions 116, and/or any other data and instructions. The software instructions 116 may comprise any suitable set of software instructions, logic, rules, or code operable to be executed by the processor 108. In certain embodiments, the memory 114 may further store a database 118. The database 118 comprises a plurality of production data items 120 and a plurality of data objects 122. In operation, the data warehouse 108 sends the plurality of production data items 120 to the data modeling system 126 and receives a plurality data objects 164 from the data modeling system 126.

### Data Modeling System

The data modeling system 126 is generally any device that is configured to process data and communicate with other components of the system 100 via the network 102. The data modeling system 126 may comprise a quantum processor 128, a classical processor 130 and a converter 134 in signal communication with a memory 148 and a network interface 132.

Quantum processor 128 may comprise one or more quantum processors operably coupled to the memory 148. The quantum processor 128 is configured to process quantum bits. The quantum processor 128 may comprise a superconducting quantum device (with qubits implemented by states of Josephson junctions), a trapped ion device (with qubits implemented by internal states of trapped ions), a trapped neutral atom device (with qubits implemented by internal states of trapped neutral atoms), a photon-based device (with qubits implemented by modes of photons), or any other suitable device that implements quantum bits with states of a respective quantum system. The quantum processor 128 is configured to execute a variational quantum cigensolver algorithm 154 to perform one or more functions described herein.

Classical processor 130 comprises one or more processors operably coupled to the memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein. For example, the one or more processors are configured to execute software instructions 150 and the variational quantum cigensolver algorithm 154 to perform one or more functions described herein.

Converter 134 is configured to convert data items represented by classical binary bits to quantum bits. Converter 134 is further configured to convert data items represented by quantum bits to classical binary bits. In certain embodiments, the converter 134 comprises a plurality of components 136 that are configured to generate and manipulate quantum bits. In the illustrated embodiment, the plurality of components 136 and the quantum processor 128 are configured to operate on a same type of quantum bits. For example, when the quantum processor 128 comprises a photon-based device (with qubits implemented by modes of photons), the plurality of components 136 may comprise optical components such as lasers, mirrors, prisms, waveguides, interferometers, optical fibers, filters, polarizers, and/or lenses.

Network interface 132 is configured to enable wired and/or wireless communications (e.g., via network 102). The network interface 132 is configured to communicate data between the data modeling system 126 and other components of the system 100. For example, the network interface 128 may comprise a WIFI interface, a local area network (LAN) interface, a wide area network (WAN) interface, a modem, a switch, or a router. The quantum processor 128 and the classical processor 130 are configured to send and receive data using the network interface 132. The network interface 132 may be configured to use any suitable type of communication protocol as would be appreciated by one of ordinary skill in the art.

Memory 148 may be volatile or non-volatile and may comprise a read-only memory (ROM), random-access memory (RAM), ternary content-addressable memory (TCAM), dynamic random-access memory (DRAM), and static random-access memory (SRAM). Memory 148 may be implemented using one or more disks, tape drives, solid-state drives, and/or the like. The memory 148 may store any of the information described in FIGS. 1, 2A, and 2B along with any other data, instructions, logic, rules, or code operable to implement the function(s) described herein. The memory 148 is operable to store software instructions 150, and/or any other data and instructions. The software instructions 150 may comprise any suitable set of software instructions, logic, rules, or code operable to be executed by the classical processor 130. The memory 148 may further store the variational quantum eigensolver algorithm 154 operable to be executed by the quantum processor 128 and the classical processor 130.

In operation, the classical processor 130 of the data modeling system 126 scans a plurality of production data items 120 stored in the memory 114 of the data warehouse 108 to determine a data structure of the plurality of production data items 120. The classical processor 130 of the data modeling system 126 receives a plurality of new data items 120 from the computing device 106 of the user 104. The classical processor 130 of the data modeling system 126 converts the plurality of new data items 124 into a plurality of structured new data items 138.

A converter 134 of the data modeling system 126 converts the plurality of production data items 120 from classical binary bits to quantum bits. In certain embodiments, the conversion process comprises generating, by the converter 134, a quantum state 142 from the plurality of production data items 120. The converter 134 of the data modeling system 126 converts the plurality of structured new data items 138 from classical binary bits to quantum bits. In certain embodiments, the conversion process comprises generating, by the converter 134, a quantum state 140 from the plurality of structured new data items 138.

The classical processor 130 of the data modeling system 126 sets variational parameters 152. The quantum processor 128 of the data modeling system 126 entangles the plurality of structured new data items 138 with the plurality of production data items 120 to obtain a plurality of correlated data items 146. In certain embodiments, the entanglement process comprises entangling, by the quantum processor 128, the quantum state 140 with the quantum state 142 to generate a quantum state 144. The quantum processor 128 of the data modeling system 126 determines a correlation score 156 between the plurality of structured new data items 138 and the plurality of production data items 120. In certain embodiments, determining the correlation score 156 between the plurality of structured new data items 138 and the plurality of production data items 120 comprises determining, by the quantum processor 128, a correlation score between the quantum states 140 and 142. The classical processor 130 of the data modeling system 126 determines if the correlation score 156 is greater than a correlation score threshold 158.

In response to determining that the correlation score 156 is not greater than a correlation score threshold 158, the classical processor 130 of the data modeling system 126 updates the variational parameters 152 and the quantum processor 128 of the data modeling system 126 repeats the entanglement process between the plurality of structured new data items 138 and the plurality of production data items 120 until the correlation score 156 is greater than the correlation score threshold 158.

In response to determining that the correlation score 156 is greater than the correlation score threshold 158, the converter 134 of the data modeling system 126 converts the plurality of correlated data items 146 from quantum bits to classical binary bits. In certain embodiments, the conversion process comprises generating, by the converter 134, the plurality of correlated data items 140 encoded in classical bits from the quantum state 144.

The classical processor 130 of the data modeling system 126 determines a data type 160 for each of the plurality of structured new data items 138. The classical processor 130 of the data modeling system 126 creates a data dictionary 162 for the plurality of structured new data items 138 based on the plurality of correlated data items 146. The classical processor 130 of the data modeling system 126 creates data objects 164 for the plurality of structured new data items 138 based on the data dictionary 162. The classical processor 130 of the data modeling system 126 reconciles the data objects 164. In certain embodiments, the reconciliation process comprises performing incremental changes to the data objects 164.

The classical processor 130 of the data modeling system 126 tests the data objects 164. In certain embodiments, testing the plurality of data objects 164 includes multiple testing scenarios. The classical processor 130 of the data modeling system 126 determines if the data objects 164 are approved. In response to determining that the data objects 164 are approved, the classical processor 130 of the data modeling system 126 deploys the data objects 164 to the data warehouse 108.

### Example Method for Real-Time Data Modeling for Data Warehouse Using Quantum Computing

FIGS. 2A and 2B illustrate an example flowchart of a method 200 for real-time data modeling for data warehouse using quantum computing. Modifications, additions, or omissions may be made to method 200. Method 200 may include more, fewer, or other operations. For example, operations may be performed in parallel or in any suitable order. For example, one or more operations of method 200 may be implemented, at least in part, in the form of the software instructions (e.g., instructions 116 and/or 150 of FIG. 1), stored on non-transitory, tangible, machine-readable medium (e.g., memories 114 and/or 148 of FIG. 1) that when executed by one or more processors (e.g., processors 110, 128, and/or 129 of FIG. 1) may cause the one or more processors to perform operations 202-236.

Method 200 starts with operation 202, where a classical processor 130 of a data modeling system 126 scans a plurality of production data items 120 stored in memory 114 of a data warehouse 108 to determine a data structure of the plurality of production data items 120.

At operation 204, the classical processor 130 of the data modeling system 126 receives a plurality of new data items 120 from a computing device 106 of a user 104.

At operation 206, the classical processor 130 of the data modeling system 126 converts the plurality of new data items 124 into a plurality of structured new data items 138.

At operation 208, a converter 134 of the data modeling system 126 converts the plurality of production data items 120 from classical binary bits to quantum bits. In certain embodiments, the conversion process comprises generating, by the converter 134, a quantum state 142 from the plurality of production data items 120. The quantum state 142 may be also referred to as a plurality of converted production data items 142.

At operation 210, the converter 134 of the data modeling system 126 converts the plurality of structured new data items 138 from classical binary bits to quantum bits. In certain embodiments, the conversion process comprises generating, by the converter 134, a quantum state 140 from the plurality of structured new data items 138. The quantum state 140 may be also referred to as a plurality of converted structured new data items 140.

At operation 212, the classical processor 130 of the data modeling system 126 sets variational parameters 152.

At operation 214, a quantum processor 128 of the data modeling system 126 entangles the plurality of structured new data items 138 with the plurality of production data items 120 to obtain a plurality of correlated data items 146. In certain embodiments, the entanglement process comprises entangling, by the quantum processor 128, the quantum state 140 with the quantum state 142 to generate a quantum state 144.

At operation 216, the quantum processor 128 of the data modeling system 126 determines a correlation score 156 between the plurality of structured new data items 138 and the plurality of production data items 120. In certain embodiments, determining the correlation score 156 between the plurality of structured new data items 138 and the plurality of production data items 120 comprises determining, by the quantum processor 128, a correlation score between the quantum states 140 and 142.

At operation 218, the classical processor 130 of the data modeling system 126 determines if the correlation score 156 is greater than a correlation score threshold 158.

In response to determining at operation 218 that the correlation score 156 is not greater than the correlation score threshold 158, method 200 continues to operation 220. At operation 220, the classical processor 130 of the data modeling system 126 updates the variational parameters 152. After performing operation 220, method 200 continues back to operation 214.

In response to determining at operation 218 that the correlation score 156 is greater than the correlation score threshold 158, method 200 continues to operation 222. At operation 222, the converter 134 of the data modeling system 126 converts the plurality of correlated data items 146 from quantum bits to classical binary bits. In certain embodiments, the conversion process comprises generating, by the converter 134, the plurality of correlated data items 140 encoded in classical bits from the quantum state 144.

At operation 224, the classical processor 130 of the data modeling system 126 determines a data type 160 for each of the plurality of structured new data items 138.

At operation 226, the classical processor 130 of the data modeling system 126 creates a data dictionary 162 for the plurality of structured new data items 138 based on the plurality of correlated data items 146.

At operation 228, the classical processor 130 of the data modeling system 126 creates data objects 164 for the plurality of structured new data items 138 based on the data dictionary 162.

At operation 230, the classical processor 130 of the data modeling system 126 reconciles the data objects 164. In certain embodiments, the reconciliation process comprises performing incremental changes to one or more of the data objects 164.

At operation 232, the classical processor 130 of the data modeling system 126 tests the data objects 164. In certain embodiments, testing the plurality of data objects 164 includes multiple testing scenarios.

At operation 234, the classical processor 130 of the data modeling system 126 determines if the data objects 164 are approved.

In response to determining at operation 234 that the data objects 164 are not approved, method 200 continues back to operation 226.

In response to determining at operation 234 that the data objects 164 are approved, method 200 continues to operation 236. At operation 236, the classical processor 130 of the data modeling system 126 deploys the data objects 164 to the data warehouse 108. After performing operation 236, method 200 ends.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a data warehouse, wherein the data warehouse comprises:
a memory configured to store:
a plurality of production data items; and
a data modeling system communicatively coupled to the data warehouse, wherein the data modeling system comprises:
a classical processor configured to:
receive the plurality of production data items from the data warehouse;
receive a plurality of new data items;
convert the plurality of new data items to a plurality of structured new data items;
send the plurality of production data items and the plurality of structured new data items to a converter;
receive a plurality of converted correlated data items from the converter;
create a data dictionary for the plurality of structured new data items based on the plurality of converted correlated data items;
create a plurality of data objects for the plurality of structured new data items based on the data dictionary;
reconcile the plurality of data objects;
test the plurality of data objects; and
in response to determining that the plurality of data objects are approved, deploy the plurality of data objects to the data warehouse;
a quantum processor communicatively coupled to the classical processor, wherein the quantum processor is configured to:
receive a plurality of converted production data items and a plurality of converted structured new data items from the converter;
set a plurality of variational parameters comprising guidelines for entangling the plurality of converted production data items with the plurality of converted structured new data items;
entangle the plurality of converted production data items with the plurality of converted structured new data items in accordance with the plurality of variational parameters to obtain a plurality of correlated data items;
determine a correlation score between the plurality of structured new data items and the plurality of production data items;
in response to determining that the correlation score between the plurality of structured new data items and the plurality of production data items is less than a correlation threshold, perform an incremental change to the plurality of variational parameters;
entangle the plurality of converted production data items with the plurality of converted structured new data items in accordance with an updated version of the plurality of variational parameters;
determine a new correlation score between the plurality of structured new data items and the plurality of production data items;
in response to determining that the new correlation score between the plurality of structured new data items and the plurality of production data items is greater than the correlation threshold, send the plurality of correlated data items to the converter; and
the converter communicatively coupled to the classical processor and the quantum processor, wherein the converter is configured to:
convert the plurality of production data items from classical binary bits to quantum bits to determine the plurality of converted production data items;
convert the plurality of structured new data items from classical binary bits to quantum bits to determine the plurality of converted structured new data items; and
convert the plurality of correlated data items from quantum bits to classical binary bits to determine the plurality of converted correlated data items.

2. The system of claim 1, wherein converting the plurality of production data items from classical binary bits to quantum bits comprises:
generating a first quantum state from the plurality of production data items.

3. The system of claim 2, wherein converting the plurality of structured new data items from classical binary bits to quantum bits comprises:
generating a second quantum state from the plurality of structured new data items.

4. The system of claim 3, wherein entangling the plurality of converted production data items with the plurality of converted structured new data items comprises:
quantum entangling the first quantum state with the second quantum state to generate a third quantum state.

5. The system of claim 4, wherein converting the plurality of correlated data items from quantum bits to classical binary bits comprises:
generating the plurality of converted correlated data items from the third quantum state.

6. The system of claim 1, wherein reconciling the plurality of data objects comprises:
performing incremental changes to one or more of the plurality of data objects.

7. The system of claim 1, wherein the quantum processor implements a variational quantum eigensolver algorithm.

8. A method comprising:
receiving a plurality of production data items from a data warehouse;
receiving a plurality of new data items;
converting the plurality of new data items to a plurality of structured new data items;
converting the plurality of production data items from classical binary bits to quantum bits to determine a plurality of converted production data items;
converting the plurality of structured new data items from classical binary bits to quantum bits to determine a plurality of converted structured new data items;
setting a plurality of variational parameters comprising guidelines for entangling the plurality of converted production data items with the plurality of converted structured new data items;
entangling the plurality of converted production data items with the plurality of converted structured new data items in accordance with the plurality of variational parameters to obtain a plurality of correlated data items;
determining a correlation score between the plurality of structured new data items and the plurality of production data items;
in response to determining that the correlation score between the plurality of structured new data items and the plurality of production data items is less than a correlation threshold, performing an incremental change to the plurality of variational parameters;
entangling the plurality of converted production data items with the plurality of converted structures new data items in accordance with an updated version of the plurality of variational parameters; and
determining a new correlation score between the plurality of structured new data items and the plurality of production data items;
in response to determining that the new correlation score between the plurality of structured new data items and the plurality of production data items is greater than the correlation threshold, converting the plurality of correlated data items from quantum bits to classical binary bits to determine a plurality of converted correlated data items;
creating a data dictionary for the plurality of structured new data items based on the plurality of converted correlated data items;
creating a plurality of data objects for the plurality of structured new data items based on the data dictionary;
reconciling the plurality of data objects;
testing the plurality of data objects; and
in response to determining that the plurality of data objects are approved, deploying the plurality of data objects to the data warehouse.

9. The method of claim 8, wherein converting the plurality of production data items from classical binary bits to quantum bits comprises:
generating a first quantum state from the plurality of production data items.

10. The method of claim 9, wherein converting the plurality of structured new data items from classical binary bits to quantum bits comprises:
generating a second quantum state from the plurality of structured new data items.

11. The method of claim 10, wherein entangling the plurality of converted production data items with the plurality of converted structured new data items comprises:
quantum entangling the first quantum state with the second quantum state to generate a third quantum state.

12. The method of claim 11, wherein converting the plurality of correlated data items from quantum bits to classical binary bits comprises:
generating the plurality of converted correlated data items from the third quantum state.

13. The method of claim 8, wherein reconciling the plurality of data objects comprises:
performing incremental changes to one or more of the plurality of data objects.

14. A non-transitory computer-readable medium storing instructions that, when executed by at least one classical processor and at least one quantum processor, cause the at least one classical processor and the at least one quantum processor to:
receive a plurality of production data items from a data warehouse;
receive a plurality of new data items;
convert the plurality of new data items to a plurality of structured new data items;
convert the plurality of production data items from classical binary bits to quantum bits to determine a plurality of converted production data items;
convert the plurality of structured new data items from classical binary bits to quantum bits to determine a plurality of converted structured new data items;
set a plurality of variational parameters comprising guidelines for entangling the plurality of converted production data items with the plurality of converted structured new data items;
entangle the plurality of converted production data items with the plurality of converted structured new data items in accordance with the plurality of variational parameters to obtain a plurality of correlated data items;
determine a correlation score between the plurality of structured new data items and the plurality of production data items;
in response to determining that the correlation score between the plurality of structured new data items and the plurality of production data items is less than a correlation threshold, perform an incremental change to the plurality of variational parameters;
entangle the plurality of converted production data items with the plurality of converted structures new data items in accordance with an updated version of the plurality of variational parameters; and
determine a new correlation score between the plurality of structured new data items and the plurality of production data items;
in response to determining that the new correlation score between the plurality of structured new data items and the plurality of production data items is greater than the correlation threshold, convert the plurality of correlated data items from quantum bits to classical binary bits to determine a plurality of converted correlated data items;
create a data dictionary for the plurality of structured new data items based on the plurality of converted correlated data items;
create a plurality of data objects for the plurality of structured new data items based on the data dictionary;
reconcile the plurality of data objects;
test the plurality of data objects; and
in response to determining that the plurality of data objects are approved, deploy the plurality of data objects to the data warehouse.

15. The non-transitory computer-readable medium of claim 14, wherein converting the plurality of production data items from classical binary bits to quantum bits comprises:
generating a first quantum state from the plurality of production data items.

16. The non-transitory computer-readable medium of claim 15, wherein converting the plurality of structured new data items from classical binary bits to quantum bits comprises:
generating a second quantum state from the plurality of structured new data items.

17. The non-transitory computer-readable medium of claim 16, wherein entangling the plurality of converted production data items with the plurality of converted structured new data items comprises:
quantum entangling the first quantum state with the second quantum state to generate a third quantum state.

18. The non-transitory computer-readable medium of claim 17, wherein converting the plurality of correlated data items from quantum bits to classical binary bits comprises:
generating the plurality of converted correlated data items from the third quantum state.

19. The non-transitory computer-readable medium of claim 14, wherein reconciling the plurality of data objects comprises:
performing incremental changes to one or more of the plurality of data objects.

20. The non-transitory computer-readable medium of claim 14, wherein the at least one quantum processor implements a variational quantum eigensolver algorithm.
